(19) United States
(12) Patent Application Publication
(10) Pub. No.: US 2016/0116826 A1
(43) Pub. Date: Apr. 28, 2016

(54) ON-CAMERA FLASHLIGHT

(71) Applicant: Qingyuan Chen, Leqing City (CN)

(72) Inventor: Qingyuan Chen, Leqing City (CN)

(73) Assignee: Yueqing Chuangyi Photography Equipment Co., Ltd.

(21) Appl. No.: 14/616,308

(22) Filed: Feb. 6, 2015

(30) Foreign Application Priority Data
Oct. 24, 2014 (CN) 201420622647.3

(51) Int. Cl. G03B 15/05; F21L 4/08; F21V 33/00

(52) U.S. Cl. CPC G03B 15/05; F21V 33/0052; F21L 4/085; F21W 2131/40

(57) ABSTRACT

This specification discloses an on-camera flashlight, comprising a flashlight body, wherein the flashlight body is provided with a flashlight battery cabin, characterized that the flashlight battery cabin is provided with multiple (e.g. six) electric contactors electrically connected to output metal plate of a battery. The flashlight battery cabin in the present invention is used for holding batteries. The flashlight battery cabin has at least six electric contactors and the six electric contact shrapnel are located at the center of the base portion of the flashlight battery cabin. Therefore, it can ensure that the batteries and the flashlight battery cabin are pressed uniformly, and the batteries do not easily swell up and thus safety is improved. Moreover, because the flashlight battery cabin is pressed uniformly, the shell does not easily damage and the service life of the camera is thus extended.

### TECHNICAL FIELD

The present invention relates to the technical field of assistant tools in photography, and in particular to an on-camera flashlight.

BACKGROUND

On-camera flashlight is an assistant tool commonly used by photographers while photographing. In prior art, the on-camera flashlight comprises a base, a head; the head is connected to the base via a hinge in a manner such that the head could rotate with respect to the base. In the base, there is a battery receiving cavity. Traditionally, the built-in power source adopted by on-camera flashlight has been AA batteries; as such, the base has incorporated a very common type of batteries which can be easily obtained by users. However, the problem is that its performance is not ideal, which mainly lies in that the recycle time is very long and the flashing times are very limited. When it is fully charged, it can only flash around 200 times at most.

To avoid the issue described above, the Chinese patent (application No. 201320787015.8) disclosed an on-camera flashlight, which comprises two battery boxes used to hold AA batteries and polymer lithium ion (li-ion) batteries respectively. Since two kinds of power sources are adopted, the flashing times are increased.

However, since the disclosed setup provides battery boxes for both kinds of power sources, the batteries within the two battery boxes must have the same specification. Batteries with different specifications cannot be used. In addition, since the flashlight is mainly powered by batteries within the battery boxes, it requires repeated charges and a supply of batteries must be carried along with the flashlight.

Moreover, for the primary principle of charge and discharge of existing flashlight, the flashlight is often charged and discharged rapidly, which will over heat the contact plate due to extended duration of use. In addition, because the electric contactor in prior art is in the form of a right angle, extended period of use will over heat the surface of the electric contactor contacting the battery. This will make the battery swell up and pose safety issues. The surface contacting the shell will also cause damage to the shell due to the heating, and thus may destroy the camera.

How to improve safety while extending service life of the camera has become an issue that needs to be urgently solved by persons skilled in the art.

### SUMMARY OF THE INVENTION

For the above, the purpose of the present utility model is to provide an on-camera flashlight to improve safety and extend service life of the camera at the same time.

In order to realize the above purpose, the present disclosure provides the following technical solution.

An on-camera flashlight comprising a flashlight body, in which the flashlight body is provided with a flashlight battery cabin, and the flashlight battery cabin is provided inside with at least six electric contactors used for electrically connecting the output metal plate of the battery.

Preferably, the six electric contactors are mounted at the center of the base portion of the flashlight battery cabin.

The on-camera flashlight also comprises an input electric jack provided on the flashlight body; the input electric jack is used for electronically connecting the output electric plug of an assistant power source.

In the on-camera flashlight, the assistant power source is a mains electricity power supply, and it is connected to the input electric jack via a power source adaptor.

Preferably, in the above on-camera flashlight, the assistant power source includes a car power inverter and power source adaptor; the car power inverter is electrically connected to the input electric jack via the power source adaptor.

Preferably, the assistant power source is a polymer li-ion battery pack.

Preferably, the flashlight body is provided with a groove; the input electric jack is located within the groove.

Preferably, the above on-camera flashlight also includes a seal cover capping the groove.

Preferably, in the above on-camera flashlight, the battery is a polymer li-ion battery or a AA battery.

Preferably, the outside of the flashlight battery cabin is provided with a battery cover.

Preferably, one side of the battery cover is rotatably connected to the flashlight body.

Preferably, the flashlight body is provided with a LED lamp. The outside of the LED lamp is provided with a LED transparent protection cover.

As can be seen from the above technical solution, the present utility model provides a flashlight battery cabin for holding batteries. The flashlight battery cabin has at least six electric contactors. Therefore, it can ensure that both the batteries and the flashlight battery cabin are pressed uniformly, the batteries will not easily swell up and thus the safety is improved. Meanwhile, since the flashlight battery cabin is pressed uniformly, the shell will not be easily damaged and service life of the camera is extended.

### DESCRIPTION OF THE DRAWINGS

In order to better illustrate technical solutions in the present utility model or prior art, accompanying drawings used in the description of embodiments or prior art are hereby briefly presented. The drawings illustrated below are only some of the embodiments of the present invention. Other drawings may also be practiced by a person of ordinary skill in the art in accordance with these drawings without exerting undue creative effort.

FIG. 1 is a structural schematic of the on-camera flashlight provided in the embodiment of the present utility model;

FIG. 2 is a systematic schematic of the on-camera flashlight provided in the embodiment of the present utility model;

FIG. 3 is a structural schematic of the on-camera flashlight using AA batteries provided in the embodiment of the present utility model;

FIG. 4 is a structural schematic of the on-camera flashlight using polymer li-ion batteries provided in the embodiment of the present utility model;

FIG. 5 is a structural schematic of the flashlight battery cabin provided in the embodiment of the present utility model.

Wherein, 101 is an input electric jack, 102 is a seal cover, 103 is an electric contactor, 104 is a control circuit, 105 is a flashlight tube, 106 is a LED lamp, 107 is a polymer li-ion battery, 108 is a car power inverter, 109 is a polymer li-ion battery pack, 110 is a power source adaptor, 111 is an external power source jack, 112 is a power source adaptor, 113 is a battery cover, 114 is an AA battery, 115 is a flashlight battery cabin, 116 is a LED transparent protection cover, and 117 is a flashlight battery cabin.

### DETAILED DESCRIPTION OF THE INVENTION

The focus of the present utility model is to provide an on-camera flashlight compatible with power sources of a wide variety of specifications, as to avoid repeated charge of battery and improve safety at the same time.

Hereinafter, embodiments are described with reference to the accompanying drawings. Furthermore, the embodiments illustrated below are not meant to limit the scope of the invention as defined in the Claims.

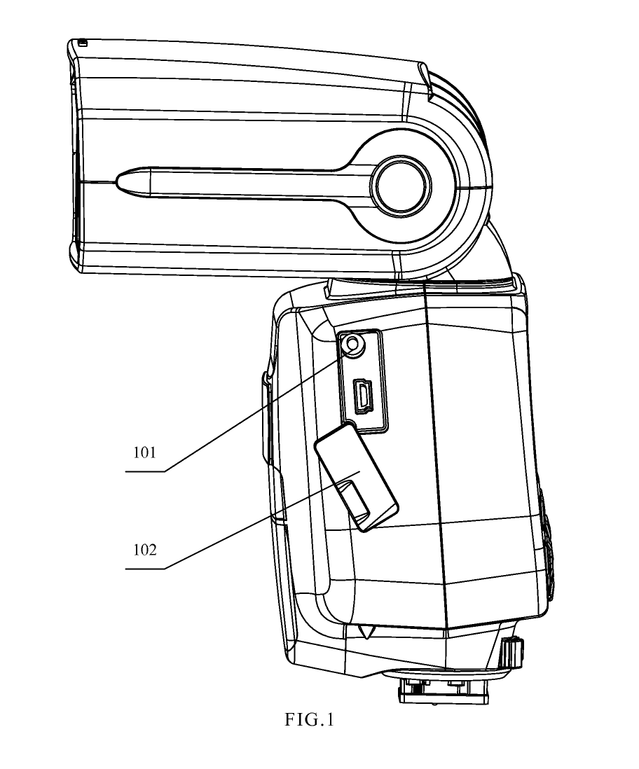

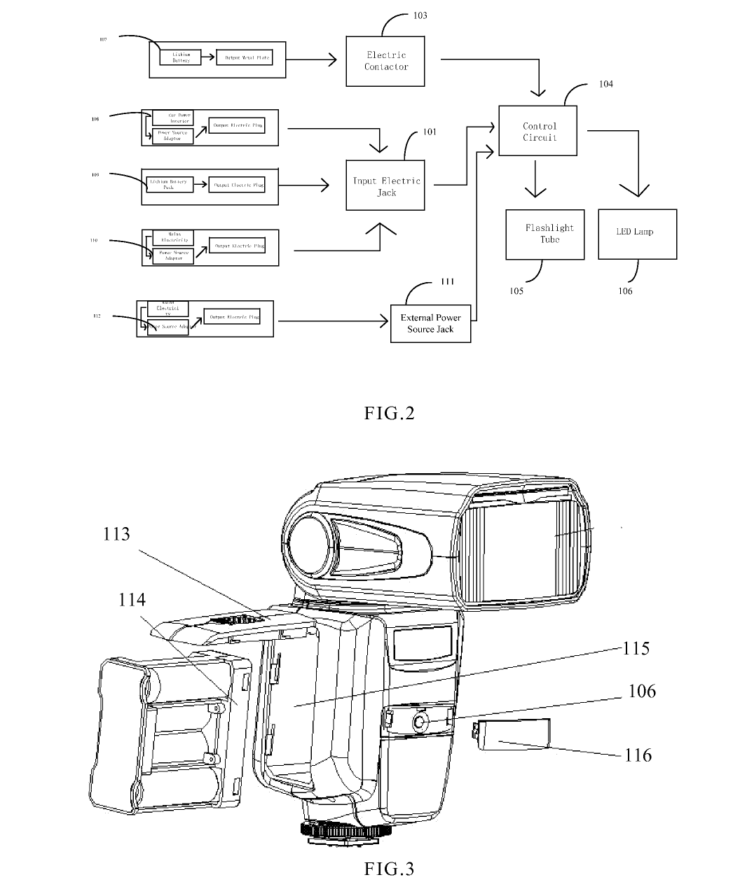

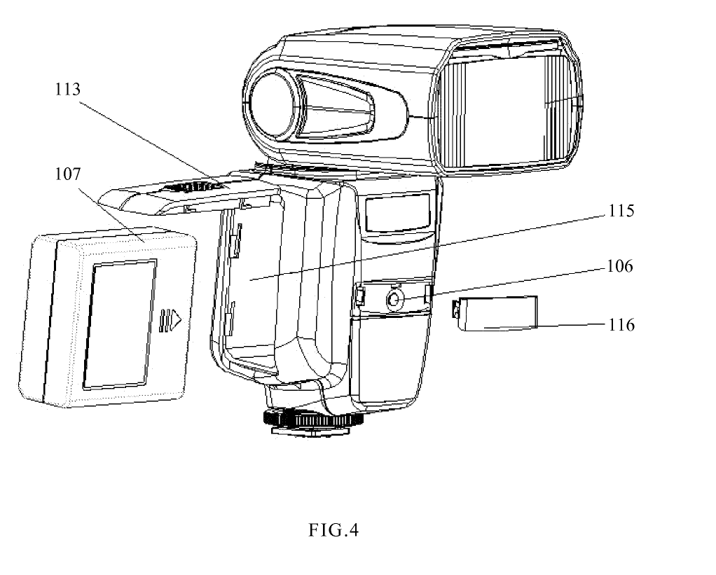

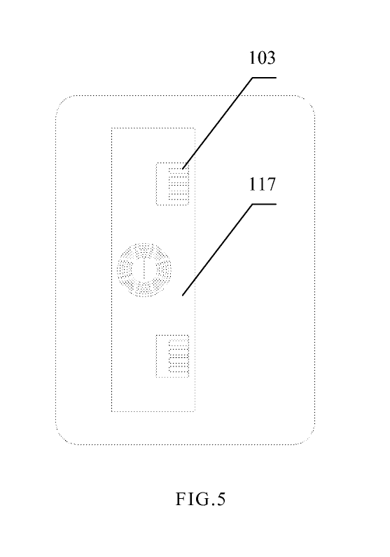

Reference is made to FIG. 1-FIG. 5. FIG. 1 is a structural schematic of the on-camera flashlight provided in the embodiment of the present utility model; FIG. 2 is a systematic schematic of the on-camera flashlight provided in the embodiment of the present utility model; FIG. 3 is a structural schematic of the on-camera flashlight using AA batteries provided in the embodiment of the present utility model; FIG. 4 is a structural schematic of the on-camera flashlight using polymer Li-ion batteries provided in the embodiment of the present utility model; FIG. 5 is a structural schematic of the flashlight battery cabin provided in the embodiment of the present utility model.

The on-camera flashlight provided in the embodiment of the present utility model comprises a flashlight body having a flashlight battery cabin 117. There is provided inside the flashlight battery cabin 117 at least six electric contactors 103 used for electrically connecting output metal plate of batteries (the battery may be a polymer li-ion battery 107 or an AA battery 114).

The flashlight battery cabin is provided with at least six electric contactors 103. Thereby, the setup can ensure that the batteries and flashlight battery cabin are pressed uniformly, and thus the batteries will not easily swell up and the safety is improved at the same time. Meanwhile, since the flashlight battery cabin is pressed uniformly, the shell will not be easily damaged and service life of the camera is extended.

In order to optimize the above solution, the six electric contactors 103 are mounted at the center of the base portion of the flashlight battery cabin 117.

Further, the present utility model also comprises an input electric jack 101 provided on the flashlight body, and the input electric jack 101 is used for electrically connecting the output electric plug of an assistant power source.

Apart from the electric jack 101, the present utility model also comprises an external power source jack 111 for connecting the power supply from batteries such as polymer li-ion battery pack and AA battery pack after being boosted via a power source adaptor to the control circuit 104. The external power source jack 111 is provided on the on-camera flashlight. What needs to be illustrated is that the external power source jack 111 may also not be arranged.

The connection relation between the input electric jack 101 and the control circuit 104 of the on-camera flashlight is the same with that between the input electric contactor 103 and the control circuit 104 of the on-camera flashlight. The control circuit 104 is electrically connected to a fill-in light lamp, the control circuit 104 is electrically connected to the input electric contactor 103, the external power source jack 111 and the input electric jack 101 respectively. The control circuit 104 is identical to the control circuit of the existing on-camera flashlight, whose function is to realize connection between a power source and the fill-in light lamp, so that the power source may supply power to the fill-in light lamp. The specific form of the circuit is not defined herein.

The input power source electric jack 101 differs from the external power source jack 111 in that: the input electric jack 101 is connected to a low voltage circuit (5V). Therefore, any battery, whether it is a car power inverter, a polymer Li-ion battery pack, or a mains electricity power supply, may be used after its voltage is reduced via the power source adaptor 110. The number of input electric jack is increased and the selection of power source adaptor 110 is expanded.

The external power source jack 111 mainly connects power supply from batteries such as mains electricity power supply, polymer Li-ion battery pack, AA battery pack after its voltage is boosted via the power source adaptor 112 to the control circuit 104.

For the on-camera flashlight provided in the present invention, an input electric jack 101 is increased and provided on the on-camera flashlight, and the flashlight can be connected to assistant power sources with various specifications via the input electric jack 101, and it only needs to provide the assistant power source with a connection wire having an identical jack. Via the increase of the input electric jack 101 capable of connecting to assistant power sources of various specification, the on-camera flashlight of the present invention can be adapted to power sources of various specifications, and thus the application scope of the on-camera flashlight is expanded. The power supply of the present invention need not be from a single battery, but can come from a lot of different choices. Therefore, the battery does not have to be recharged again and again, and it is not necessary to carry batteries.

The flashlight battery cabin 117 of the present invention is used for holding batteries. There is provided within the flashlight battery cabin 117 four pairs of electric contactors. Compared to the existing one pair of electric contact plates, four pairs of electric contactors are safer, and the contact plates will not easily over heat from extended use. The battery is also provided with one pair of electric contact plates.

In a specific embodiment of the present invention, the assistant power source is a polymer Li-ion battery pack 109. The assistant power source can also include a bus power inverter 108 and a power source adaptor. The car power inverter 108 is electrically connected to the input electric jack 101 via the power source adaptor. The power source adaptor is used for stabilizing voltage of the car power inverter 108. The assistant power source may also be a mains electricity power supply, and it is electrically connected to the input electric jack 101 via the power source adaptor. The power source adaptor is used for stabilizing voltage of the mains electricity power supply.

In a specific embodiment of the present utility model, the flashlight body is provided with a groove, and the input electric jack 101 is located therein. The present utility model also comprises a seal cover 102 capping the groove for keeping out the dirt.

In a specific embodiment of the present utility model, there is provided outside of the flashlight battery cabin 117 a battery cover 113. The battery cover 113 is used for protecting the batteries and presenting water. Meanwhile, it may also prevent the batteries from falling off.

In a specific embodiment of the present utility model, the flashlight body is provided with a LED lamp 115. The LED lamp 115 is provided with a LED transparent protection cover 116. The LED lamp 115 using low power may be used as a persistent light source for a long time to match the existing camera in photographing. Compared with flashlight body with relatively high power acting as light source, the current invention saves power and improves longetivity of the flashlight.

By referring to the above illustrations of the disclosed embodiments, persons of ordinary skill in the art could realize or practice the present invention. The fundamental principle defined herein may be realized in other embodiments without departing from the spirit or scope of the present utility model. Therefore, the present utility model will not be limited to those embodiments described herein, but should be in accordance with the broadest scope having the same principle and novel characteristics as disclosed herein.

We claim:

1. An on-camera flashlight, comprising a flashlight body; wherein the flashlight body is provided with an assistant power source and a flashlight battery cabin, wherein the flashlight battery cabin further comprises a plurality of electric contactors for electrically connecting output metal plate of a battery.

2. The on-camera flashlight of claim 1, wherein the electric contactors are provided at a center of a base portion of the flashlight battery cabin.

3. The on-camera flashlight of claim 1, further comprising an input electric jack mounted on the flashlight body, wherein the input electric jack is used for electrically connecting an output electric plug of an assistant power source.

4. The on-camera flashlight of claim 1, wherein the assistant power source is a mains electricity power supply and is electrically connected to the input electric jack via a power source adaptor.

5. The on-camera flashlight of claim 1, wherein the assistant power source, further comprises a car power inverter and a power source adaptor; wherein the car power inverter is electrically connected to the input electric jack via the power source adaptor.

6. The on-camera flashlight of claim 1, wherein the assistant power source is a polymer li-ion battery pack.

7. The on-camera flashlight of claim 1, wherein the flashlight body is provided with a groove, and the input electric jack is located therein.

8. The on-camera flashlight of claim 7, further comprising a seal cover capping the groove.

9. The on-camera flashlight of claim 1, wherein the battery is a polymer lithium ion battery or an AA battery.

10. The on-camera flashlight of claim 1, wherein an outside of the flashlight battery cabin is provided with a battery cover.

11. The on-camera flashlight of claim 10, wherein one side of the battery cover is rotatably mounted on the flashlight body.

12. The on-camera flashlight of claim 1, wherein the flashlight body is provided with a LED lamp; wherein the LED lamp is externally connected to a LED transparent protection cover (116).
